(19) United States
(12) Patent Application Publication
(10) Pub. No.: US 2023/0140096 A1
(43) Pub. Date: May 4, 2023

(54) DRIVER RISK MANAGEMENT TOOL, AND METHOD FOR USING IT

(71) Applicant: Daniel T. Shive, Winfield, IL (US)

(72) Inventor: Daniel T. Shive, Winfield, IL (US)

(21) Appl. No.: 17/967,115

(22) Filed: Oct. 17, 2022

Related U.S. Application Data
(63) Continuation of application No. 63/275,312, filed on Nov. 3, 2021.

(51) Int. Cl. G06Q 10/06

(52) U.S. Cl. CPC G06Q 10/0635; G06Q 40/08

(57) ABSTRACT

A method for using a risk management tool to evaluate driver safety for drivers employed by a customer, the risk management tool evaluating a variety of driver safety-related data, amalgamating this data, and generating one or more risk scores corresponding to an individual driver, while preferably allowing customers to select data suppliers of their choice.

### PRIORITY DATA

This application is a continuation of provisional U.S. Ser. No. 63/275,312, filed Nov. 3, 2021, as to which priority is requested.

### BACKGROUND OF THE INVENTION

The present invention generally relates to driver risk management tools and programs which may be used by fleet management companies, insurance companies, and other companies and individuals to evaluate the safety and/or insurance risk of individual drivers.

Currently, fleet management companies (“FMCs”) (i.e., companies such as Donlen that assist companies with a fleet (“fleet companies,” which are often self-insured) in procuring and disposing of vehicles, and everything in between), and insurance companies are required to analyze many different driver risk management-related platforms in order to evaluate the risk performance for an individual driver. Data derived from evaluating individual driver risk performance, and risk scoring, are used by FMC customers and insurance companies to evaluate individual driver safety risk, generate premiums or to take other actions required to evaluate the safety risk and/or insure a driver. For example, data showing driver behavior (“telematics,” which may be gleaned from programs resident on the insured's automobile, which can track data such as speed, acceleration/deceleration tendencies, collisions, etc.), and data derived from driver motor vehicle records, driver training records, driver collision history, driver “camera” violations, dash camera infractions, etc., are currently stored on different loss control platforms rather than being aggregated. Additionally, FMCs and insurance companies may only aggregate data that is purchased from a preferred, known supplier, and they may not allow the driver/customer to choose alternate suppliers to aggregate. For example, while some companies may aggregate some loss control data, they may only aggregate data if the end user/customer enrolls in that company's service offerings and uses that company's associated providers.

FMC's often partner with several sub-suppliers (e.g., CEI, Safety First, etc.). As an example, one sub-supplier may handle MVR and driver training, while another sub-supplier may handle telematics, etc. from a “preferred” perspective. FMCs may minimally integrate data to their own customer portal, forcing clients to move from one product portal to the next for in-depth details. Sub-suppliers are not able to aggregate their risk management-related data for various reasons, including because portals do not interact with each other, risk scoring has different bases, etc. FMC customers and insurance companies may be forced to purchase offerings based on risk management-related data that is provided by a particular sub-supplier, even if those companies would prefer other, omitted data elements that they believe may better suit their needs. For example, if the sub-supplier eDriving is used, a customer of eDriving must use its mobile telematics, even if the customer believes that another mobile telematics system better suits its needs. As another example, Donlen may be restricted to using the CEI portal for MVR and driver training, despite the fact that with the CEI portal, telematics data is not integrated. In short, while each safety sub-supplier may have various available services, none have all desired services, which can be aggregated to provide a single view of an individual driver's risk.

FMC customers and insurance companies are therefore currently required to analyze data from many different driver risk management-related platforms in order to assess a driver's risk performance. Synthesizing and analyzing all driver data relevant to assessing driver risk performance is difficult and currently not available, and certain data can be inadvertently omitted or not considered appropriately if sufficient care is not taken.

Accordingly, there is a need for providing a single driver risk management-related platform with aggregated data collected from all relevant sources, including those from any supplier of the customer's choosing; this aggregation approach is referred to here as a “holistic” approach to driver risk management evaluation and risk scoring. Preferably, this holistic driver risk management tool is able to evaluate individual driver risk based on a host of driver performance and driver historical information. It would also be preferred to allow the FMC customer/driver to select suppliers of her/his choice, in order to generate the data used by this holistic driver management tool.

The most “reactive” portion of driver safety is when a collision occurs. This is often referred as the “claim handling process” or “first party repair.” Through the analysis of systems, services and processes, the present invention can assist clients in reducing direct, collision-related costs and reduce downtime.

The most impactful and “proactive” portion of driver safety concerns driver risk management. Beyond a basic MVR and risk assessment, there are many elements of driver safety, including but not limited to: driver training, policy consultation and development, telematics, camera violations, rewards, and so on. Programs that capture and analyze this driver risk management-related data make a substantial difference on the bottom-line financials and human capital for FMCs and insurance companies and their customers. The present invention is an important way to be “proactive” about driver safety, providing transparency and visibility for all loss control service and driver compliance results.

### SUMMARY OF THE INVENTION

The objects mentioned above, as well as other objects, are solved by the present invention, which overcomes disadvantages of prior driver loss control programs, while providing new advantages not previously associated with them. This summary is provided to introduce a selection of concepts in a simplified form that are further described below in the Detailed Description, so that the claimed invention may be better understood. However, this summary is not intended to limit the scope of the claimed subject matter.

In a preferred embodiment of the invention, a method is provided for using a risk management tool to evaluate driver safety for drivers employed by a customer. With this method, one or more computer programs may be populated with driver identification data that includes information uniquely identifying vehicles and linking this vehicle information to corresponding driver information for such vehicles. The one or more computer programs may also be populated with various sources of driver safety-related data, including at least motor vehicle record information. Service business rules of the customer may be applied using the one or more computer programs, thereby generating and assigning a risk score corresponding to each of the various sources of driver safety-related data for drivers employed by the customer. These risk scores may be normalized and amalgamated by the one or more computer programs using the service business rules, to generate a single overall, individual risk score for each of the drivers.

The customer may be a fleet management company, a customer or a fleet management company, or an insurance company, or another type of company or individual. The vehicle information may include vehicle identification numbers (VINs). The driver information may include employee badge or other employee identification information.

The service business rules may include one or more of the following: user profiles for the customer; rules concerning driver training for the customer; rules concerning predetermined rewards or incentives provided to certain drivers that are employees of the customer; and rules permitting the use of multiple safety sub-suppliers for providing the various sources of driver safety-related data, even if the sub-suppliers provide some of the same type or category of driver safety-related data.

The predetermined rewards or incentives may be provided to certain drivers who achieve a low overall, individual risk score.

An additional step of the method of the present invention may include that of a vendor providing the risk management tool to the customer, and the vendor generating a revenue stream based upon providing to the customer the one or more computer programs. Services for obtaining such a revenue stream may include the vendor providing to the customer: customized reports that include driver risk scores; driver safety-related data obtained from one or more preferred sub-suppliers selected by the customer, or other sub-suppliers not preferred by the customer.

The various sources of driver safety-related data may include but are not limited to data generated from one or more of the following sources: telematics; red cameras; vehicle dashboard cameras; driver compliance requirements from the customer, and any resulting reporting or testing data; and cell phones.

In another embodiment of the present invention, a driver risk management tool is provided for use in evaluating safety of drivers of a customer. The tool includes one or more computer programs populated with: (i) driver identification data that includes information uniquely identifying vehicles, linked to corresponding driver information for such vehicles; and (ii) various sources of driver safety-related data, including at least motor vehicle record information. The one or more computer programs apply service business rules of the customer, generating and assigning a risk score corresponding to each of the various sources of driver safety-related data for each of the drivers, and then normalizing and amalgamating the risk scores for each source of driver safety-related data using the service business rules, to generate a single overall, individual risk score for each of the drivers. According to the service business rules, safety sub-suppliers providing driver safety-related data may be chosen by the customer.

### Definition of Claim Terms

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a schematic illustration of various types of driver safety-related data that could be analyzed to provide a “driver scorecard” or risk score for a particular driver;

FIG. 2 is a schematic view of sample risk scores assigned to a particular driver for different categories of driver safety-related data; and

FIG. 3 is a schematic view of an example of a driver overall risk or safety score that might be seen on a computer dashboard (the color may be blue or green given the “safe driver” score here, whereas a high-risk score might be colorized in red, for example).

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

Referring first to FIGS. 1, 5, 6 and 9, the present invention generally concerns a driver risk/loss control management tool which aggregates all available driver risk management-related services and individual program driver risk data and scoring into a single platform/tool, ensuring that individuals and companies such as fleet management and insurance companies can evaluate all data relevant to predicting driver risk performance in a single customer portal. Examples of driver data sources which may be included in this holistic approach include but are not limited to those shown in FIG. 1, including but not limited to: telematics driver behavior data derived from on-board information; driver motor vehicle records (MVRs are typically available at the Secretary of State for the individual state, while some safety sub-suppliers have the ability to provide MVR-related information on a continuous basis to their customers); driver training records; driver past collision history; driver “red camera” violations (e.g., Verra Mobility/ATS is a safety sub-supplier that tracks and stores red light camera violations); dash camera infractions (e.g., Nauto provides dash cameras to drivers and their employees); 1-800 HMD (feedback from 1-800 “how's my driving” calls can be integrated and used to assign risk for certain corresponding drivers), etc.

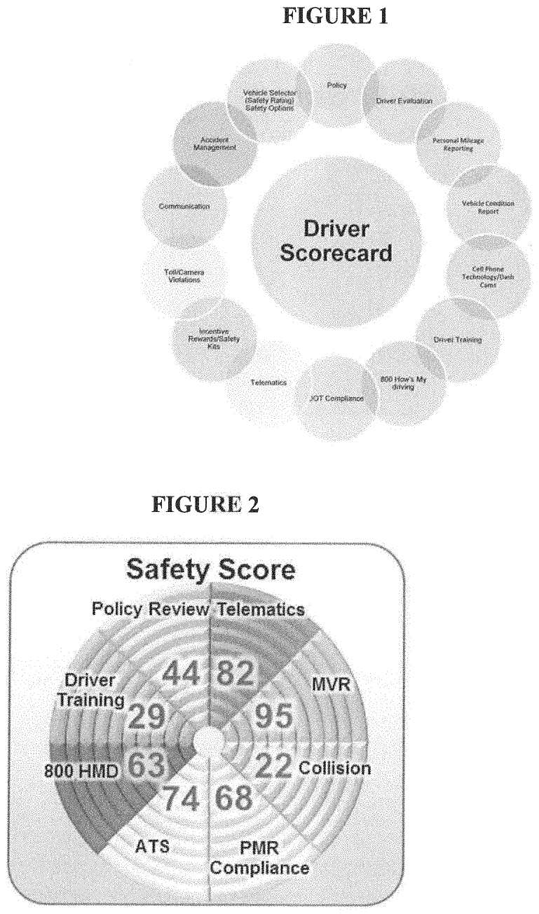

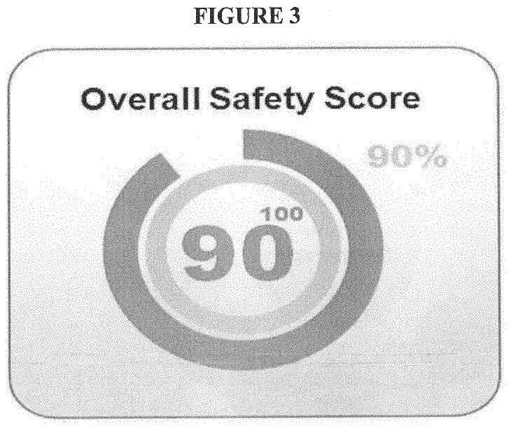

Referring to FIG. 2, a particular driver generates individual scores for each of various data safety categories, as shown. Review, analysis and amalgamation of these individual scores then allows the computation of a single, holistic risk or “safety score” for an individual driver, as shown in FIG. 3.

Individual risk scores corresponding to different safety data categories for a particular driver (e.g., telematics, MRV, etc.) may be based on different risk scoring systems and/or algorithms. They are preferably “normalized” according to the preferences of the customer. For example, two notable safety sub-suppliers that provide telematics data are Geotab and Verizon; each provides different risk scores based upon telematics, using different algorithms, that may analyze or weigh certain data differently, such as speeding, speeding over a certain threshold, collisions, acceleration, etc. Geotab might assign to a particular driver a telematics risk score of “85.” Based upon the same telematics data, but weighted or scored differently, Verizon might assign to the same driver a telematics risk score of “80.” Preferably, the computer program(s) of the present invention permit the customer to use these scores how it wishes (e.g., to average them, or to weight the Geotab score as 60% of the overall telematics score, perhaps because Geotab uses the telematics data in a way that the customer prefers, as opposed to the way Verizon uses the telematics data).

Computer dashboards may be used which provide easy-to-read, colorized, visually-indicative/recognizable “volume” or “power” (collectively here “meter”) indicators of driver risk (e.g., such as shown on a vehicle odometer, or a scale, etc.), based upon different driver safety-related data categories. (For example, the use of the red color may indicate drivers at the highest risk, yellow can indicate a moderate risk driver, and green can indicate a low-risk driver.) In this manner, driver risk can be quickly viewed when organized at, e.g., a fleet level, a territorial level within a fleet, a regional level within a fleet, or at an individual driver level.

One preferred way to link a driver with her/his corresponding vehicle (or pool of vehicles used, in the case of a “pool” driver), is to link the vehicle VIN number with the driver(s) assigned to drive that vehicle by the customer. This linking may be done using an RFID reader that reads a badge of the customer's employee. A client (e.g., McDonald's) or a safety sub-supplier may input this linking information into the computer program(s) of the present invention. Tables 1-3, below, are examples of how data can be used to populate a computer program(s) for an FMC customer.

TABLE 1

| Page | Elements |
|---|---|
| Main Page Search | Driver Data |
| | Vehicle Data |
| | Level Data -- customer hierarchy (e.g., |
| | nation, region, branch) |
| | Services Enrolled (e.g., three or five driver |
| | safety-related services used) |
| | Service Business Rules |
| | User Profiles |
| Dashboard | Products evaluated by different safety data |
| | category |
| | Business Rules by service |
| | Apply Exceptions |
| | Drilldown capabilities in total and by service |

TABLE 2
Vehicle Data - Sample Requirements
Year, Make, Model
VIN#
Client Level Structure (3-10 Levels)
Assigned Driver or Pool
*Assigned Driver = Driver Data

TABLE 3
Driver Data - Sample Requirements
Driver Name
Email Address
Unique ID - Employee #
Client Level Structure (e.g., nation,
region/territory, branch, etc.)

According to the present invention, each customer can provide “service business rules” that inform the programming of the software according to the present invention, using standard API for communication between the vendor and customer computers, for example. These customer service business rules can be used to dictate how safety scores for different data categories can be “normalized” and amalgamated for the purpose of providing/assigning an overall safety risk score for a particular driver. Again, given that each safety sub-supplier has its own scoring algorithms, each customer (e.g., FMC, insurance company, fleet customer, or other company or individual) can have its own service business rules. In addition to “normalizing” rules, service business rules may include notification/action rules; as an example, if two or three speeding violations of a certain type (e.g., 20 mph over the posted limit) occur, or a single DUI occurs, the rules may require that the customer must be notified as to that particular driver, and/or the customer must take some particular action for that particular driver (e.g., probation, suspension, termination). (MVRs include ACD violation codes, assigned for, e.g., speeding violation ranges above certain posted limits, which can be included within the safety-related data that is analyzed by the present invention.) As another example, a particular customer's service business rules may dictate that new employee-drivers must take certain driver training classes, and that drivers violating certain rules must take additional driver training classes.

Service business rules may also include “user profiles,” i.e., the fleet manager has access to all safety-related data and all risk scores for all employee-drivers, the regional manager only has access to such data within a particular region or territory, and the branch manager only has access to such data for drivers within his branch, etc.

Preferably, the customer is provided with the flexibility to switch safety sub-suppliers, or to selectively use safety-related data from a particularly (e.g., non-preferred), safety sub-supplier, at the customer's discretion, without disrupting the aggregation of data, and without interrupting the continuous monitoring of drivers and the assignations of risk scores. However, such flexibility may come at a cost by the vendor, as explained below.

An important goal of a holistic driver risk management program is to identify the specific risk factors that result in high-risk drivers. Given this identification, remediation of the individual driver, from a high-risk driver, to a moderate or low-risk driver, may be possible using driver training and education, for example, as further explained below.

In order to facilitate driver remediation, a customer may have a predetermined assignation of driver training. This driver training may be ad hoc, e.g., a Fall training cycle may be assigned, or it may be predetermined and curriculum-based, e.g., new drivers receive certain specific training classes and performance reviews, or driver training classes are provided on an ongoing basis and/or specific training is tailored based on specific driver risk scores (e.g., speeding drivers may receive a certain type of training class, while drivers receiving one or more DUIs may receive another type of training class). A customer's service business rules may be designed with these driver training protocols in place. A customer may wish to provide its employee-drivers, or those with higher risk, with safety kits (e.g., flares, triangles, fire extinguishers).

A customer's service business rules may also incorporate a predetermined rewards/incentives program(s). For example, employee-drivers may receive certain incentives for achieving an overall low risk score (e.g., plaques, monetary incentives such as bonuses, more rapid career advancement, etc.). Conversely, employee-drivers may receive penalties for having a high risk score, such as docked pay, extra driver training, probation, suspension or termination.

Some circumstances will restrict the ability of the holistic program to provide an individual driver with a risk rating, or restrict the use of some data for use with the program. For example, while a specific driver may be rated as a low risk on all separate components, that driver's MVR (motor vehicle record) status could be “suspended,” which would qualify the driver as “ineligible” for receiving a risk rating. Another restriction is that MVR data cannot be transferred from one system to another from an FCRA (Fair Credit Reporting Act) perspective. In this case, a score and a rating may be able to be sent to a customer, but further details may not be forthcoming. Still another restriction may be when telematics data is not available for a particular driver or class of drivers.

The present invention may be used to generate various sources of revenue. For example, one revenue stream may be generated from safety sub-suppliers who wish to be a “preferred” supplier for a particular FMC or insurance company, using standard API for example. Another revenue stream may be generated by FMCs or insurance companies who wish to import data from another (“non-preferred”) selected safety sub-supplier, who may have data different than the preferred safety supplier (e.g., data exchange costs per service may be assessed at, e.g., $1 per driver per month). Certain safety-related services may be outsourced by the customer's vendor, and standard offerings, grouped by identification of tasks to be accomplished, can be provided, with a corresponding vendor fee assigned to each such different offering; safety-related services which may be outsourced include driver compliance enforcement communications and related disciplinary actions. Still another revenue stream may be generated by the provision of customized reports at a customer's specific request. Other revenue streams may be based on software costs for creating or modifying the computer program(s) related to the present invention, including but not limited to data feed costs, IT hardware costs, etc.

Use of the present invention also allows customers to achieve cost savings in a variety of ways. For example, the identification and termination of continuing high-risk drivers can allow the company to avoid lawsuits and ensuing litigation costs. Another example is that based on the driver safety data accumulated, targeted driver remediation can occur. Still another example is that by using the present invention to lower costs related to claims, either neutralizing or lowering driver insurance premiums can occur. Use of the present invention also provides low-risk drivers with more insurance flexibility (e.g., insurance companies are happy to insure such drivers at reasonable premiums, while high-risk drivers will have less such flexibility, and be required to pay higher premiums). As a less obvious example, tracking risk scores using more comprehensive driver safety-related data, in a holistic manner, may lead customers to select vehicles that are safer, more economical, etc. Customers may decide to only expend resources for safety kits to drivers who truly need them on (e.g., low risk drivers may not receive them). Use of the present invention may allow more tailored rewards/enhancement programs. After analyzing cell phone-driving-related data, customers may opt to block or restrict certain types of cell phone use by employee-drivers during.

Another less obvious way in which the present invention can allow customers to achieve cost savings concerning driver compliance. There are various way to assess driver compliance with employer/customer requests, including: assessing PMR (personal miles reporting) compliance (i.e., it is typically the employee's responsibility to identify personal miles driven in an company car); assessing PM (preventative maintenance) compliance (i.e., customers provide a PM schedule to employees, such as how often to change the oil, fill/rotate the tires, etc.); and assessing policy review compliance (i.e., customers provide employees with vehicle policies relating to how to use, or misuse, a vehicle, and drivers may be tested on their understanding of such policies). The present invention can be used to better assess employee compliance, such as by evaluating and assigning a risk score to these driver compliance requirements.

The above description is not intended to limit the meaning of the words used in the following claims that define the invention. Persons of ordinary skill in the art will understand that a variety of other designs still falling within the scope of the following claims may be envisioned and used. It is contemplated that these additional examples, as well as future modifications in structure, function, or result to that disclosed here, will exist that are not substantial changes to what is claimed here, and that all such insubstantial changes in what is claimed are intended to be covered by the claims.

I claim:

1. A method for using a risk management tool to evaluate driver safety for drivers employed by a customer, comprising the steps of:
populating one or more computer programs with driver identification data that includes information uniquely identifying vehicles and linking this vehicle information to corresponding driver information for such vehicles;
populating the one or more computer programs with various sources of driver safety-related data, including at least motor vehicle record information;
using the one or more computer programs to apply service business rules of the customer, thereby generating and assigning a risk score corresponding to each of the various sources of driver safety-related data for each of the drivers employed by the customer; and
using the one or more computer programs to normalize and amalgamate the risk scores for each source of driver safety-related data using the service business rules, and generating a single overall, individual risk score for each of the drivers.

2. The method of claim 1, wherein the customer comprises at least one of the following: a fleet management company; and an insurance company.

3. The method of claim 1, wherein the vehicle information comprises VIN numbers.

4. The method of claim 1, wherein the driver information comprises employee badge or other employee identification information.

5. The method of claim 1, wherein the service business rules comprise user profiles for the customer.

6. The method of claim 1, wherein the service business rules comprise rules concerning driver training for the customer.

7. The method of claim 1, wherein the service business rules comprise rules concerning predetermined rewards or incentives provided to certain drivers that are employees of the customer.

8. The method of claim 7, wherein the predetermined rewards or incentives are provided to the certain drivers who achieve a low overall, individual risk score.

9. The method of claim 1, further comprising the steps of a vendor providing the risk management tool to the customer, and the vendor generating a revenue stream based upon providing to the customer one or more computer programs capable of achieving the steps of claim 1.

10. The method of claim 1 further comprising the steps of a vendor providing the risk management tool to the customer, and the vendor generating a revenue stream based upon providing to the customer customized reports that include driver risk scores.

11. The method of claim 1 further comprising the step of obtaining at least some of the driver safety-related data from one or more preferred sub-suppliers selected by the customer.

12. The method of claim 12, further comprising the step of a vendor providing the risk management tool to the customer, and the vendor generating a revenue stream based upon providing to the customer an ability to use the driver safety-related data from one or more safety sub-suppliers selected by the customer, wherein the one or more safety sub-suppliers do not comprise the preferred sub-suppliers.

13. The method of claim 1, wherein the various sources of driver safety-related data comprise data generated from one or more of the following sources: telematics; red cameras; vehicle dashboard cameras; driver compliance requirements from the customer, and any resulting reporting or testing data; and cell phones.

14. The method of claim 1, wherein the various sources of driver safety-related data include sub-suppliers, and wherein the safety business rules permit the use of multiple sub-suppliers, even if the sub-suppliers provide some of the same type or category of driver safety-related data.

15. A driver risk management tool for use in evaluating safety of drivers of a customer, comprising:
one or more computer programs populated with: (i) driver identification data that includes information uniquely identifying vehicles, linked to corresponding driver information for such vehicles; and (ii) various sources of driver safety-related data, including at least motor vehicle record information;
wherein the one or more computer programs apply service business rules of the customer, and generate and assign a risk score corresponding to each of the various sources of driver safety-related data for each of the drivers; and
wherein the one or more computer programs normalize and amalgamate the risk scores for each source of driver safety-related data using the service business rules, and generate a single overall, individual risk score for each of the drivers.
